(19) United States
(12) Patent Application Publication
(10) Pub. No.: US 2025/0372911 A1
(43) Pub. Date: Dec. 4, 2025

(54) RIGID WIRING CONNECTOR

(71) Applicant: Sargent Manufacturing Company, New Haven, CT (US)

(72) Inventor: Patrick Ryan, Shrewsbury, MA (US)

(73) Assignee: Sargent Manufacturing Company, New Haven, CT (US)

(21) Appl. No.: 19/213,210

(22) Filed: May 20, 2025

Related U.S. Application Data
(60) Provisional application No. 63/653,297, filed on May 30, 2024.

(51) Int. Cl. H01R 13/50; H01R 13/422; H01R 13/516; H01R 43/18

(52) U.S. Cl. CPC H01R 13/50; H01R 13/422; H01R 13/516; H01R 43/18

(57) ABSTRACT

A rigid wiring connector that can be reduced in size to properly connect electrical components across a door or similar medium. There are several breakpoints at predetermined distances along the body of the rigid wiring connector, indicating to users where to break the connector so that it may be a desired length. Wiring may be threaded through the connector, enabling power and/or data to flow between electrical components.

### RELATED APPLICATIONS

This application claims the benefit under 35 USC 119(e) of U.S. Application Ser. No. 63/653,297, filed May 30, 2024, titled “RIGID WIRING CONNECTOR”, the entire contents of which is hereby incorporated by reference herein.

### FIELD

Disclosed embodiments are related to electronic wire harnesses and connectors and in particular connectors of selectable length.

### BACKGROUND

Electrical components in buildings may need electrical connections through doors, walls, or other constructions. Wire connections enable power or data to transfer between electrical components. Flexible ribbon cables may be used to connect spaced-apart components but are prone to damage due to bending from installation or use. Flexible ribbon cables may have loose wiring that may need to be restrained in order to fit the cables in a confined space. This may also damage the electrical connections or increase difficulty of installation.

### SUMMARY

According to one aspect, an electrical connector is disclosed. The electrical connector may include a body, at least one conduit extending along a path through the body, configured to receive at least one electrical conductor, and a plurality of breakpoints along the body, the breakpoints oriented to intersect the path of the conduit.

According to another aspect, an electrical connector is disclosed. The electrical connector may include a rigid body and at least one conduit extending along a path through the body. The connector may further include at least one electrical conductor disposed in the at least one conduit and a plurality of equally spaced breakpoints scored into the body by scores and with the scores indicating the breakpoints along the body. The breakpoints may be oriented to intersect the path of the at least one conduit, along half a length of the body.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a perspective view of an embodiment of a rigid wiring connector;

FIG. 1B is a perspective view of the reduced rigid wiring connector shown in a reduced-length configuration;

FIG. 2 is a perspective view of one embodiment of a connector of an electrical component configured to mate with the rigid wiring connector;

FIG. 3 is a top view of an alternate embodiment of a rigid wiring connector;

FIG. 4 is a top view of an alternate embodiment of a rigid wiring connector;

FIG. 5 is a top view of an alternate embodiment of a rigid wiring connector;

FIG. 6 is a perspective view of an alternate embodiment of a rigid wiring connector;

FIG. 6A is a perspective cross-sectional view taken along line 6A-6A of FIG. 6;

FIG. 7 is a perspective view of support cover for a rigid wiring connector.

### DETAILED DESCRIPTION

The Inventors have appreciated that it may be desirable for an electrical connector to be configured as a rigid wiring connector and be breakable at predetermined segments so that a user may select a desired length to sturdily bridge an electrical connection. This feature may be desirable for installing electrical wiring in buildings, by allowing users to connect electrical components across doors or walls which have a range of standard thicknesses.

In some embodiments, a connector includes a rigid body with at least two outer faces that may connect at least two electrical components, and an outer surface. The rigid body may have at least one conduit extending along a path through the connector. The conduit may receive at least one electrical conductor to connect the at least two electrical components at termini on each of the at least two outer faces. A user is able to reduce the size of the body of the connector by breaking the body, allowing the connector to be sized to a desired length so that it may connect to electrical components that are a set distance apart. There may be breakpoints or indications on the outer surface of the body to indicate to users where to break the body to achieve the desired length. The breakpoints may be equally spaced apart or spaced at other predetermined distances. The breakpoints may intersect the conduit path, so that the conduit path length is reduced when the body is broken. Upon breaking the rigid wiring connector, an unwanted portion of the body is discarded, and a new outer surface of the rigid body is exposed. It should be appreciated that the new outer surface is substantially similar to the outer surface of the discarded portion.

The body is made of at least one rigid material so that the body does not easily bend, or twist. Additionally, the material is also suitably brittle so that it may break when desired. The body may also be made of an electrically insulated material. Alternatively, the body may be made of a variety of materials to achieve the desired properties.

The surface of the rigid wiring connector has a plurality of breakpoints on the outer surface of the body. Each breakpoint is substantially a line or groove that circumscribes the surface. A first breakpoint is a standard distance from one of the outer faces. A second breakpoint may be the same or different distance from the first breakpoint. Subsequent breakpoints continue to be regularly spaced apart along the outer surface of the body. This pattern may continue to the second outer face, or it may end after a desired number of repetitions. For example, the breakpoint pattern may only cover half the length of the connector body. In alternate embodiments, breakpoints may be varying distances apart from the previous breakpoint. This may be desirable for applications where the distance between electrical components has a variety of standard lengths that do not increase in regular intervals. In alternate embodiments the breakpoint pattern may begin at both the first outer face and the second outer face.

In some embodiments, the breakpoints may be scored into the body and cut deep enough into the body so that a user may easily break the rigid wiring connector at a desired location. Each scored breakpoint may be cut to approximately the same depth and have approximately the same width. Additionally, scored breakpoints are approximately parallel to the outer faces. Users may break the rigid wiring connector by hand or with the use of tools such as pliers, or wire cutters. It should be appreciated that the depth or size of the cut of the scored breakpoint correlates to the desired strength of the rigid wiring connector. If a sturdy connector is needed, breakpoints may be shallow and would require additional tools to cut. Alternatively, if there is a high tolerance for bending, breakpoints may be deep and be broken by hand.

Electrical wiring may also traverse through the body, terminating at the surface of each outer face, creating at least one conductive contact point on each outer face. When the outer faces interact with electrical components, the conductive contact points touch corresponding contact points on the electrical components and allow power or data to transfer across the wiring. The wiring may be threaded through the connector prior to the connector being sized, so that the wire remains the same length as the connector.

In some embodiments the rigid wiring connector has at least two parallel outer faces that interact with at least two corresponding electrical components. A variety of connection types are contemplated for the shape and functionality of the rigid wiring connector. In one embodiment, the body is prismatically shaped, so that the two identical bases constitute the outer faces, while additional faces constitute the outer surface of the rigid wiring connector. At least a portion of the cross section of the body are identical to the outer faces. The shape of the outer faces is dependent on the desired electrical components the rigid wiring connector is connecting. For example, if the rigid wiring connector is connecting two hexagonal shaped female electrical components, the two outer faces would be similarly male shaped. The shape of the outer faces does not limit the rigid wiring connector, and it is appreciated that the outer faces may be a variety of regular or irregular shapes or be shaped to standard connectors such as USB or HDMI connectors. Additionally, the location of the wiring and conductive contact points may correspond to the desired electrical components in a similar fashion.

In another embodiment the two outer faces are different shapes. This enables a user to connect two different shaped electrical components. The cross sections of at least one portion of the body are identical to at least one of the outer faces of the connector. Therefore, if a user breaks the rigid wiring connector at a breakpoint, the newly exposed outer face is identical to the previously exposed outer face and can thus mate with the corresponding component.

In yet another embodiment, the two outer faces, may be nonparallel so that the cross sections of the body does not follow a straight line. For example, the body may be V-shaped, L-shaped, or curved. The cross sections of at least one portion of the body are identical to at least one of the outer faces of the connector. The body may have a plurality of breakpoints circumscribing the body and substantially parallel to at least one outer face along a portion of the body. If a user breaks the rigid wiring connector at a breakpoint, the newly exposed outer face is identical to the previously exposed outer face.

In yet another embodiment, the body may have at least three outer faces so that the body branches in multiple directions. The body may have one or more additional branches. For example, the body may be Y-shaped, T-shaped, X-shaped, 3-Way Elbow shaped, or curved. The cross sections of at least one portion of the body are identical to at least one of the outer faces of the connector. The body may have a plurality of breakpoints circumscribing the body and substantially parallel to at least one outer face along a portion of the body. If a user breaks the rigid wiring connector at a breakpoint, the newly exposed outer face is identical to the previously exposed outer face.

In yet another embodiment, the breakpoints may be cut in such a way that they extend through the body of the rigid wiring connector. Such a feature would enable users to easily break apart the rigid wiring connector at a desired length. In this embodiment, the breakpoints may reduce the overall strength of the rigid wiring connector. The Inventor has therefore appreciated that in this embodiment the rigid wiring connector may have an additional support cover to provide additional strength to the rigid wiring connector. The support cover is made of at least one rigid material or a plurality of materials and shaped so that it may securely fit over the rigid wiring connector. It may be secured to the rigid wiring connector by snap-fitting to the connector or it may be secured with the use of fasteners, adhesives, or other methods for connecting pieces. The support cover has a plurality of breakpoints, spaced in an identical pattern to the breakpoints of the rigid wiring connector. This enables a user to reduce the size of the support cover to the same size as the rigid wiring connector. It should be appreciated that a support cover may be used with any of the previously described embodiments or similar embodiments.

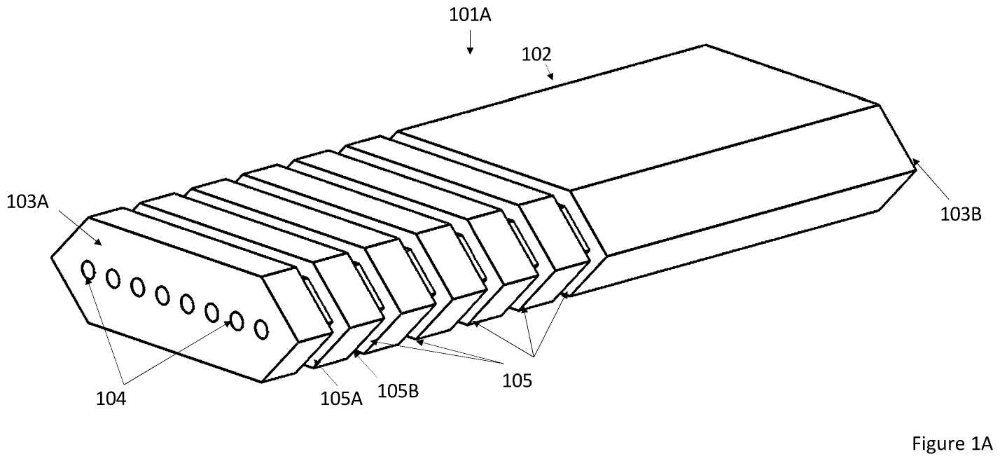

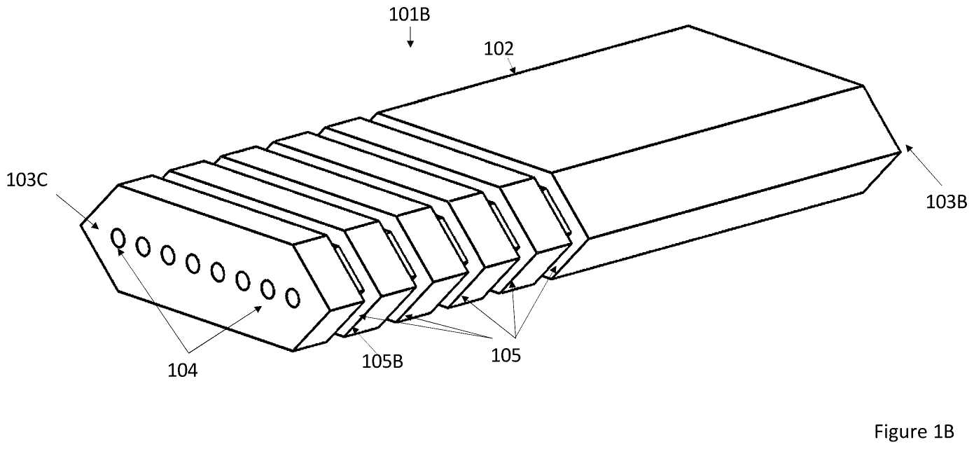

Turning to FIGS. 1A-7, specific non-limiting embodiments are described in further detail. It should be understood that the various systems, components, features, and methods described relative to these embodiments may be used either individually and/or in any desired combination as the disclosure is not limited to only the specific embodiments described herein.

FIG. 1A depicts one embodiment of the invention as a body 101A having an outer surface 102 and at least two parallel outer faces 103A and 103B in different planes. The body 101A may have a plurality of breakpoints 105 that circumscribe the outer surface 102 of the body 101A and are parallel to each other. Breakpoints 105 have a substantially similar depth and width, although they need not have matching depths and widths. A first breakpoint 105A is a predetermined distance from a first edge of a first outer face 103A and the same predetermined distance from a second breakpoint 105B. The distance between additional breakpoints may be the same predetermined distance. Alternatively, the distance between breakpoints may vary. Breakpoints 105 are deep enough so that they may assist a user in breaking the body 101A at a desired breakpoint, thus reducing the size of the body 101A. For example, a user may reduce the length of the body 101A by breaking the body 101A at the first breakpoint 105A and discard material between the first outer face 103A to the first breakpoint 105A.

FIG. 1B depicts the reduced body 101B. Upon reducing the body 101B, a new outer face 103C is exposed at the approximate location of the first breakpoint 105A of FIG. 1A. The new outer face 103C is identical to the first outer face 103A of FIG. 1A. Additionally, the second breakpoint 105B of FIG. 1A is now the closest breakpoint 105 to an outer face 103C. Similarly, a user may reduce the size of the body 101A by breaking or cutting the body 101A at any breakpoint 105, thus reducing the body 101A in a similar manner depicted in FIG. 1B at a desired breakpoint 105.

Additionally, the body may have at least one conduit through the outer surface, alternatively the body 101A may have a plurality of conduits 104 though the outer surface 102. Conduits 104 have an opening at a first outer face 103A (or 103C in FIG. 1B) and an additional opening at a second outer face 103B, the first outer face 103A may be substantially opposite the second outer face 103B. The conduits 104 may form a path through the body 101A. It should be appreciated that the breakpoints 105 may intersect the conduits 104 along the path. Electrical wiring or other conductors not depicted may be threaded through the conduits 104, or otherwise disposed in the conduits, terminating at a first termini of face 103A and a second termini at face 103B, enabling electrical power and/or data to transmit. It should be appreciated that wiring may be threaded through the conduits prior to the connector being broken or cut so that upon breaking or cutting the body, the wire is also broken or cut to the same length. Alternatively, the interior of the conduits 104 may be coated with an electrically conductive material enabling power and/or data to transmit.

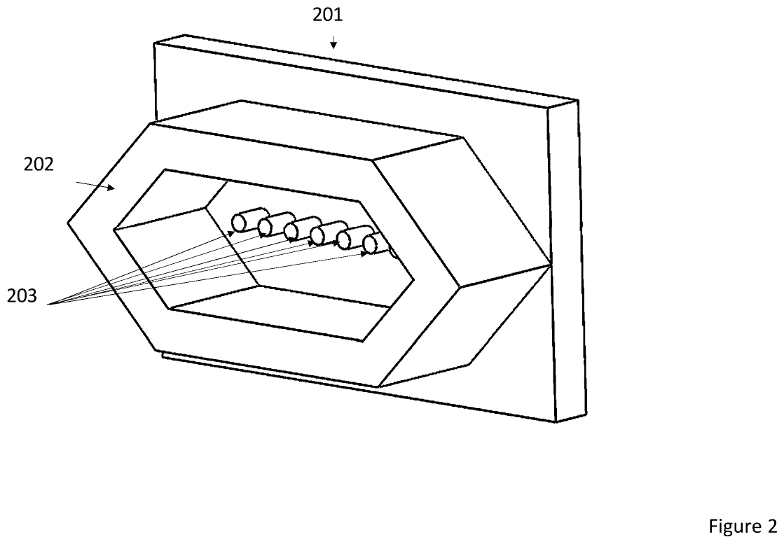

It should be appreciated that the outer faces 103A, 103B, and 103C and the conduits 104 of FIGS. 1A-B are shaped to interact with an electrical component. FIG. 2 shows embodiment of an electrical component 201. The electrical component may have a surface 202. The profile of the surface 202 has substantially the same profile as the outer faces 103A, 103B, and 103C of FIG. 1A-B. Additionally, the electrical component 201 may have a plurality of electrical contact pins 203. The electrical contact pins 203 are sized and spaced substantially similarly to the conduits 104 of FIG. 1A-B, allowing the electrical contact pins 203 to fit into the conduits 104 of FIG. 1A-B. The contact pins 203 may connect to an additional circuit not shown. It should be understood that both outer faces 103A (or 103C of FIG. 1B) and 103B of FIG. 1A may interact with an electrical component 201 of FIG. 2, thus creating an electrical connection between two electrical components 201.

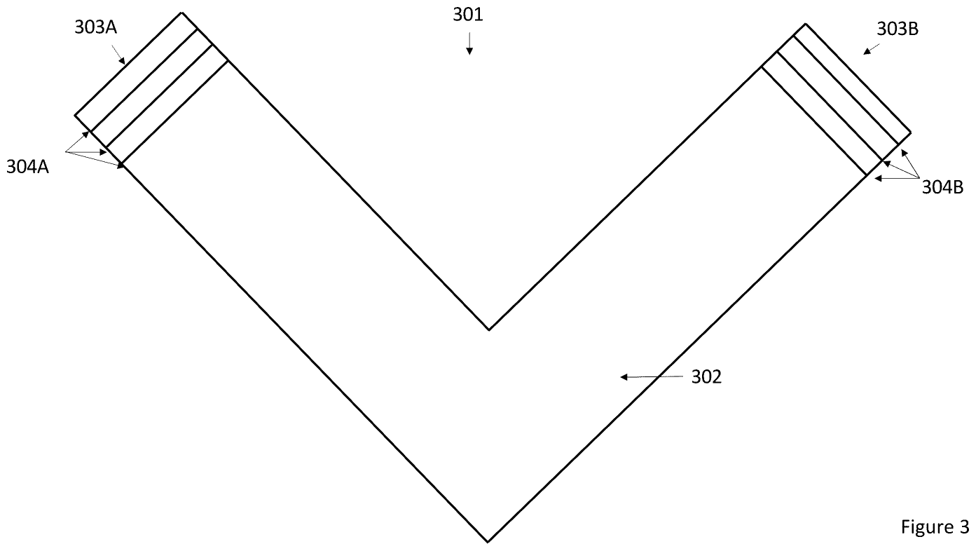

FIG. 3 depicts an alternative embodiment of the invention as a body 301 having an outer surface 302 and at least two outer faces 303A and 303B which are non-parallel so that the body is V-shaped. The body 301 may have a plurality of breakpoints 304A and 304B that circumscribe the outer surface 302 of the body 301. The breakpoints 304A are parallel to the outer face 303A and the breakpoints 304B are parallel to the outer face 303B. Breakpoints 304A and 304B have a substantially similar depth and width, although they need not have matching depths and widths. The breakpoints 304A and 304B are deep enough so that they may assist a user in breaking the body 301 at a desired breakpoint, thus reducing the size of the body 301.

Additionally, the body 301 may have a plurality of conduits (not shown) through the outer surface 302. The conduits have an opening at a first outer face 303A and an additional opening at a second outer face 303B. Electrical wiring not depicted may be threaded through the conduits, terminating at faces 303A and 303B, enabling electrical power and/or data to transmit. Alternatively, the interior of the conduits may be coated with an electrically conductive material enabling power and/or data to transmit.

It should be appreciated that the outer faces 303A, and 303B, of FIG. 3 are shaped to interact with an electrical component to form an electrical connection. Each face 303A and 303B may interact with a separate electrical component allowing an electrical connection between two electrical components to be made by the connector. The orientation of the outer faces 303A and 303B enables the body 301 to connect noncolinear electrical components. It should be appreciated that the orientations of the outer faces 303A and 303B are not limiting.

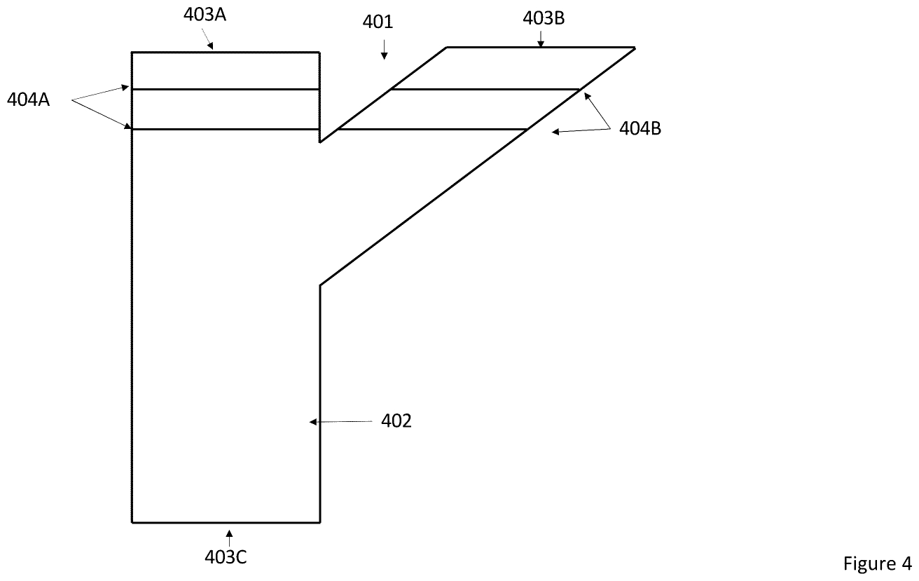

FIG. 4 depicts an alternative embodiment of the invention as a body 401 having an outer surface 402 and at least three outer faces 403A, 403B, and 403C so that the body is Y-shaped. The body 401 may have a plurality of breakpoints 404A and 404B that circumscribe the outer surface 402 of the body 401. The breakpoints 404A are parallel to the outer face 403A and the breakpoints 404B are parallel to the outer face 403B. Breakpoints 404A and 404B have a substantially similar depth and width, although they need not have matching depths and widths. The breakpoints 404A and 404B are deep enough so that they may assist a user in breaking the body 401 at a desired breakpoint, thus reducing the size of the body 401.

Additionally, the body 401 may have a plurality of conduits (not shown) through the outer surface 402. The conduits have an opening at a first outer face 403A, an additional opening at a second outer face 403B, and another additional opening at a third outer face 403C. Electrical wiring not depicted may be threaded through the conduits, terminating at faces 403A, 403B, and 403C enabling electrical power and/or data to transmit. Alternatively, the interior of the conduits may be coated with an electrically conductive material enabling power and/or data to transmit.

It should be appreciated that the outer faces 403A, 403B, and 403C of FIG. 4 are shaped to interact with an electrical component to form an electrical connection. Each face 403A, 403B and 403C may interact with a separate electrical component allowing an electrical connection between three electrical components to be made by the connector. It should be appreciated that the orientations of the outer faces 403A, 403B and 403C are not limiting.

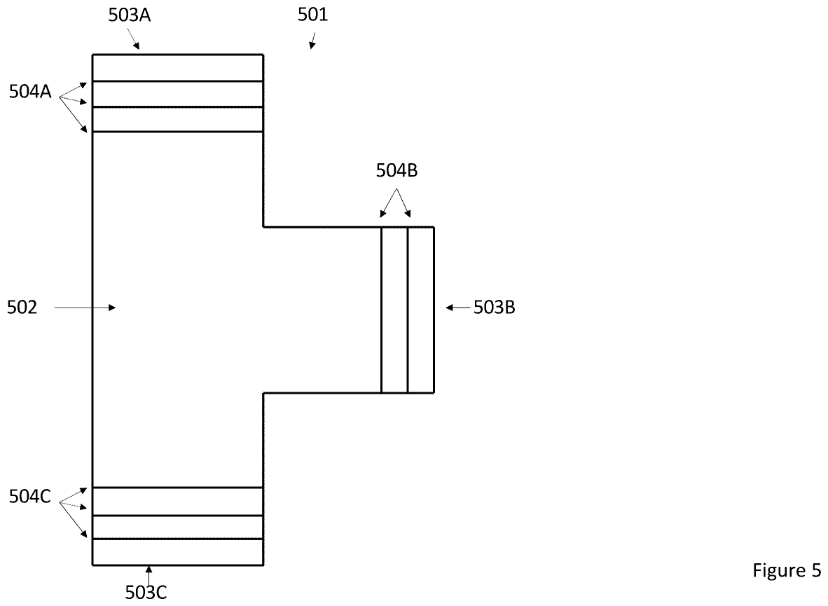

FIG. 5 depicts an alternative embodiment of the invention as a body 501 having an outer surface 502 and at least three outer faces 503A, 503B, and 503C. The body 501 may have a plurality of breakpoints 504A, 504B, and 504C that circumscribe the outer surface 302 of the body 301. The breakpoints 504A are parallel to the outer face 503A, the breakpoints 504B are parallel to the outer face 503B, and the breakpoints 504C are parallel to the outer face 503C. Breakpoints 504A, 504B, and 504C have a substantially similar depth and width, although they need not have matching depths and widths. The breakpoints 504A, 504B, and 504C are deep enough so that they may assist a user in breaking the body 301 at a desired breakpoint, thus reducing the size of the body 501.

Additionally, the body 501 may have a plurality of conduits (not shown) through the outer surface 502. The conduits have an opening at a first outer face 503A, an additional opening at a second outer face 503B and another additional opening at a third outer face 503C. Electrical wiring not depicted may be threaded through the conduits, terminating at faces 503A, 503B, and 503C enabling electrical power and/or data to transmit. Alternatively, the interior of the conduits may be coated with an electrically conductive material enabling power and/or data to transmit.

It should be appreciated that the outer faces 503A, 503B, and 503C of FIG. 5 are shaped to interact with an electrical component to form an electrical connection. Each face 503A, 503B, and 503C may interact with a separate electrical component and create a connection between two electrical components. It should be appreciated that the orientations of the outer faces 503A, 503B, and 503C are not limiting.

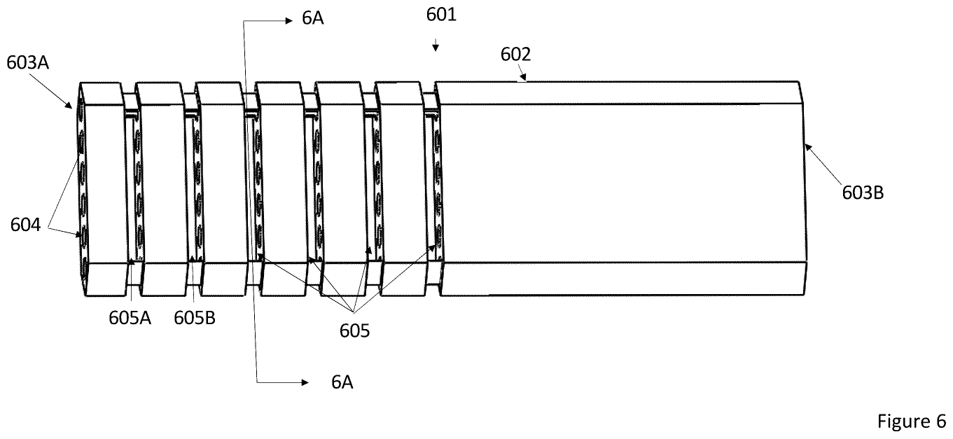

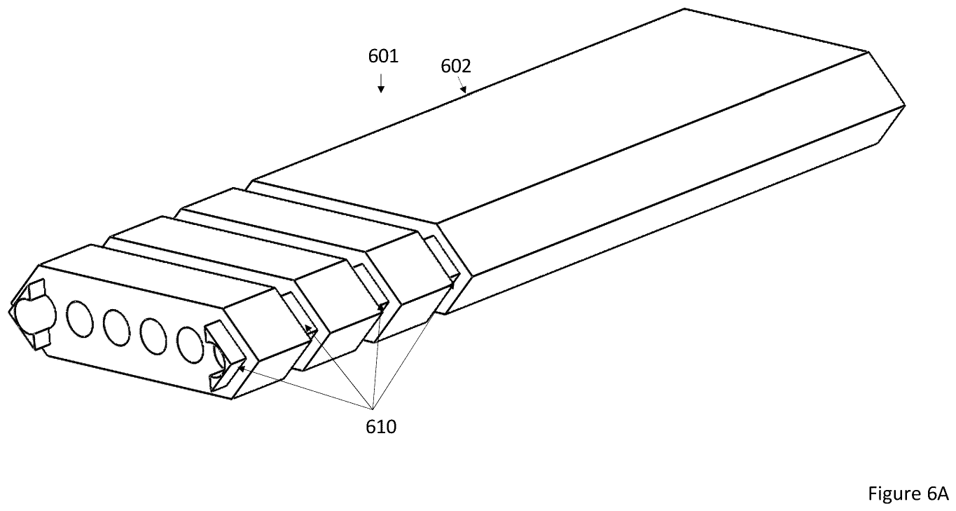

FIGS. 6 and 6A depicts another embodiment of the invention as a body 601 having an outer surface 602 and at least two outer faces 603A and 603B, with a plurality of conduits 604 forming a path through the body 601. The body 601 may have a plurality of breakpoints 605 that extend through the body 601. Breakpoints 605 have a substantially similar width, although they need not have matching widths. A first breakpoint 605A is a predetermined distance from a first outer face 603A and the same predetermined distance from a second breakpoint 605B. The distance between additional breakpoints is the same predetermined distance. Breakpoints 605 are cut through the body so that they may assist a user in breaking the body 601 at a desired breakpoint, thus reducing the size of the body 601. For example, a user may reduce the length of the body 601 by breaking the body 601 at the first breakpoint 605A and discard material between the first outer face 603A to the first breakpoint 605A. As shown in FIG. 6A, the connector is held together with support tabs 610 defining the spacing of the breakpoints. That is, breaking the connector at the breakpoints severs the tabs 610. Any suitable size and configuration of the tabs is contemplated taking into account balancing the desired rigidity of the connector and the ease with which it can be broken to length.

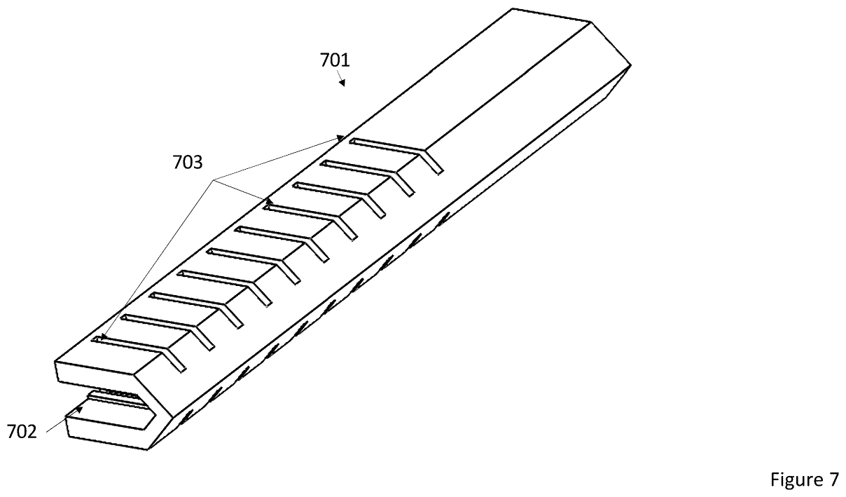

FIG. 7 depicts a support cover for the body 601 of FIG. 6. The support cover 701 is shaped so that it may fit over the body 601 of FIG. 6 and provide extra strength to the body 601 by snap-fitting to the body 601. The inner profile 702 of the support cover 701 is similarly shaped to the outer surface 602 of FIG. 6. The support cover may have a plurality of breakpoints 703 along the support cover 701 in the same pattern as the breakpoints 605 of the connector of FIG. 6. The breakpoints 703 may be scored into the support cover 701, or cut through the support cover 701, so that they may assist a user in breaking the support cover 701 at a desired breakpoint, thus reducing the size of the support cover to the size of the body 601 of FIG. 6. It should be understood that the foregoing description of the invention is intended merely to be illustrative thereof and that other embodiments, modifications, and equivalents of the invention are within the scope of the invention recited in the claims appended hereto. Further, although each embodiment described above includes certain features, the invention is not limited in this respect. Thus, one or more of the above-described or other features of the rigid wiring connector, may be employed singularly or in any suitable combination, as the present invention is not limited to a specific embodiment.

What is claimed is:

1. An electrical connector, comprising: a body;
at least one conduit extending along a path through the body, configured to receive at least one electrical conductor; and
a plurality of breakpoints along the body, the breakpoints oriented to intersect the path of the at least one conduit.

2. The electrical connector of claim 1, wherein the body includes a first outer face and wherein the at least one conduit has a plurality of first termini at the first outer face.

3. The electrical connector of claim 2, wherein the body includes a second outer face opposite the first outer face and wherein the at least one conduit has a plurality of second termini at the second outer face.

4. The electrical connector of claim 1, wherein the breakpoints are scored into the body.

5. The electrical connector of claim 4, wherein the body is breakable at the breakpoints.

6. The electrical connector of claim 1, wherein the breakpoints are through the body.

7. The electrical connector of claim 6, further comprising a support cover having a plurality of support cover breakpoints, the support cover configured to interact with the electrical connector.

8. The electrical connector of claim 1, wherein the breakpoints are equally spaced along the body, beginning at a first edge of the body.

9. The electrical connector of claim 1, wherein the breakpoints are equally spaced along the body, beginning at a first edge of the body, and ending at a distance half of a length of the body.

10. The electrical connector of claim 1, wherein the body is rigid.

11. The electrical connector of claim 1, wherein the electrical conductor is a wire.

12. The electrical connector of claim 1, wherein the at least one conduit is coated in a conductive material.

13. An electrical connector, comprising:
a rigid body;
at least one conduit extending along a path through the body;
at least one electrical conductor disposed in the at least one conduit; and a plurality of equally spaced breakpoints scored into the body, the breakpoints oriented to intersect the path of the at least one conduit, along half a length of the body.

14. The electrical connector of claim 13, wherein the electrical conductor is a wire.

15. The electrical connector of claim 13, wherein the at least one conduit is coated in a conductive material.
